(19) United States
(12) Patent Application Publication
(10) Pub. No.: US 2008/0250109 A1
(43) Pub. Date: Oct. 9, 2008

(54) Method and system for tracking time over instant messenger

(76) Inventor: Gabriel Jakobson, Las Vegas, NV (US)

Correspondence Address: PetNote LLC;Attn: Steven Rueben, 3862 Ruskin Street, Las Vegas, NV, 89147, US

(21) Appl. No.: 11/784,670

(22) Filed: Apr. 9, 2007

(51) Int. Cl. G06F 15/16

(52) U.S. Cl. 709/206

(57) ABSTRACT

A method and apparatus for allowing the tracking the starting, ending and duration of instant messenger (“IM”) interactions, are disclosed. An IM application, running on an electronic device, may provide functionality to capture the duration and history of an interaction between users over an IM infrastructure. The IM application may regulate an interactive session (“session”) over IM, capturing a users' explicit agreement to engage in a session, the user's pausing and ending of the session, and the history of the session (text, voice, files etc. exchanged between the parties as part of the IM session). In addition, monetary rate may be associated with a session and a monetary charge, associated with the monetary rate and session duration, may be captured, confirmed, reported and/or billed. The record of an IM session may be synchronized among users' IM applications and exported to other applications or for storage. Tracking IM sessions may be made a part of IM client applications, may be part of a module which may be associated with one or more IM client applications, or may be a part of applications and devices capable of exchanging messages over an IM infrastructure.

### FIELD OF INVENTION

The present invention relates to the use of instant messaging over electronic devices. More particularly, the present invention relates to tracking time (for example, billable time for services rendered) using instant messenger systems.

### BACKGROUND OF THE INVENTION

Instant messaging (or “IM”) has become a popular way for people to exchange messages in real time. Examples of popular instant messenger services include Qnext®, Windows Live Messenger®, AOL Instant Messenger®, Yahoo! Messenger®, Skype®, Google Talk®, NET Messenger Service®, Jabber®, QQ®, Excite/Pal iChat® and ICQ®. Instant messaging applications use various protocols to allow users, using client-sided applications on various devices, to connect to servers which broker the messaging communications between users. Instant messenger users can add other users—often people with whom they converse frequently—to a contact list. Many instant messaging applications offer a history feature, which allows a user to review a recording of their chat conversation with another user. Instant messaging applications work on a wide-variety of electronic devices (e.g. personal computers, cellular phones, personal digital organizers, etc.), allowing and behooving users to be “always on” (i.e. maintain a persistent connection to other online users throughout the day.)

With the proliferation of instant messaging and its becoming a ubiquitous form of communication, a growing number of users use IM to communicate with professional service providers. For example, customers may choose IM to obtain tax advice from their accountant, medical advice from their doctor, legal advice from their attorney, etc. The advantages of using IM are numerous, including: the service provider may be able to handle multiple interactions simultaneously; the customer may obtain real-time advice; and, the customer may engage in a casual, friendly conversation and “slip in” professional advice questions. Professional service providers typically bill for their time dispensing information. Some of the advantages of IM, listed above, may be to the detriment of the service provider. It may be hard to keep accurate time for each customer when engaged in multiple IM interactions with multiple customers. It may be difficult to justify billing for an entire IM interaction when the customer claims a large portion of the interaction may have been along personal lines. Transposing elements and attributes of an IM interaction (e.g. date, time, duration, matter discussed, exact advice given, etc.) into a system of record the professional may be using to invoice the customer, may require effort.

While IM products have bridged many of the communication challenges among heterogeneous users engaged in the exchange of billable professional advice, they lack a framework for making such exchange efficient. IM products do not currently offer means of obtaining a customer's agreement, over IM, to start and stop a billable IM interaction. IM products do not offer an efficient means of capturing a billable (or otherwise, time-tracked) IM session and importing all attributes and history of an IM session, into a systems of record (for example, an invoicing application.)

### DESCRIPTION OF THE DRAWINGS

For a more complete understanding of the present invention and further advantages thereof, references are now made to the following Detailed Description, taken in conjunction with the drawings, in which:

FIG. 1 is a generalized block diagram illustrating an instant messenger system with enhancement modules to track the duration of an IM session, according to one embodiment.

FIG. 2 is a generalized block diagram illustrating an instant messenger application with IM session timing functionality, according to one embodiment.

FIG. 3 FIG. 3 is a generalized block diagram illustrating the interaction between two instant messenger applications (“IM”) with session tracking.

FIG. 4 is a generalized block diagram illustrating a communication flow between two time-tracking modules according to one embodiment.

FIG. 5 is a generalized block diagram illustrating a system for tracking time in IM sessions, according to one embodiment.

FIG. 6 is a generalized block diagram illustrating the operation of an IM application enabled for tracking a timed IM session, according to one embodiment.

FIG. 7 is a generalize block diagram illustrating synchronization of data between IM applications enabled for tracking a timed IM session, according to one embodiment.

FIG. 8 is a generalized block diagram illustrating the association of an IM session rate, such as a monetary rate, to time-tracked IM sessions, according to one embodiment.

FIG. 9 is a generalized block diagram illustrating the use of a “widget” for tracking IM sessions, according to one embodiment of the present invention.

FIGS. 10A and 10B are generalized block diagrams illustrating the interaction of session-tracking IMs with a system of record, according to one embodiment of the present invention.

### SUMMARY OF THE INVENTION

The present invention provides a method and system for tracking the duration of an interaction (“session”) over an instant messenger (“IM”) infrastructure. For example, the interaction may be providing professional services using an IM service. An IM application, running on an electronic device, may allow a user to track the starting time, ending time and duration of a timed IM session (“timed session”) with one or more other users. IM applications may include, but not be limited to, stand-alone applications, browser plug-ins, on-screen widgets and gadgets, PDA and cellular phone modules, server-sided applications rendered on a client machine, etc.

Users engaged in a timed session may be required to jointly agree on the starting time and/or ending time of the timed session. Coordinated Universal Time (“UTC”) services may be referenced by the IM of one or more users to establish a uniform measurement of time. In various embodiments different schemes may be used to control the logic of starting, pausing and ending a timed session: either user may start and stop a timed session; both users may start and stop a timed session; the user starting a timed session may be the only one who may stop the timed session, etc.

Timed session information may be exported into systems of record. For example, in a timed session between a professional services provider (“provider”) and a customer, the provider may export the timed session information into a billing or invoicing system. In another possible embodiment a time-tracking module may be an integral part of an IM application. In alternate embodiments, various computer applications (e.g. applications used to track billable time for professionals, including but not limited to accounting software, medical billing, legal billing, etc.) may interface with an IM infrastructure for tracking time electronically.

### DETAILED DESCRIPTION

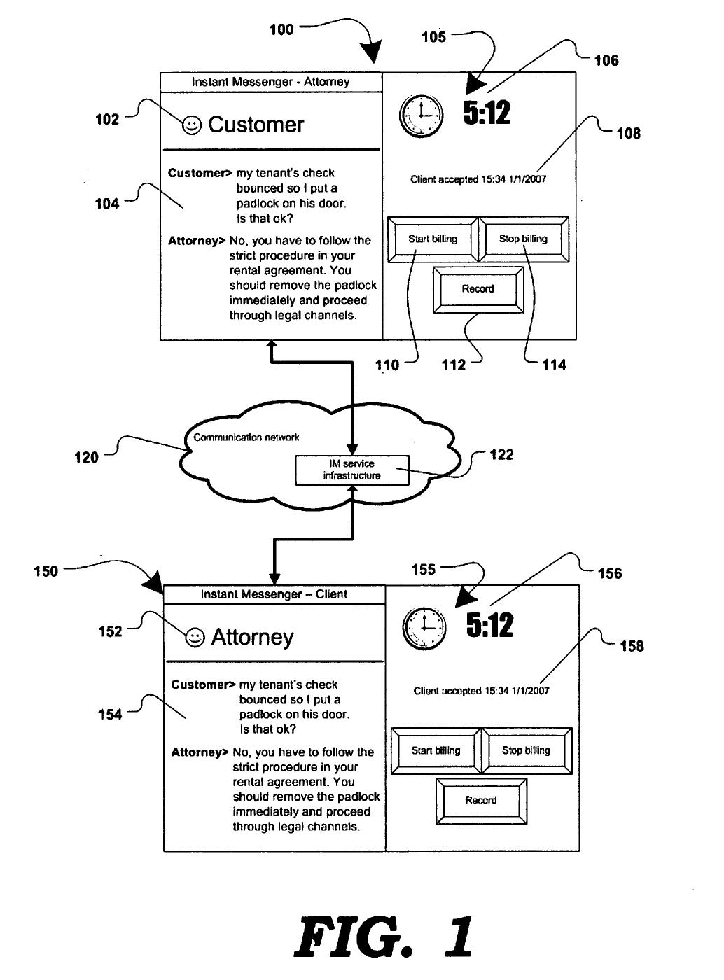

FIG. 1 is a generalized block diagram illustrating an instant messenger system with enhancement modules to track the duration of an IM session, according to one embodiment. IM applications 100 and 150 may operate on any electronic device (e.g. computer, cellular phone, PDA, etc.) and communicate over IM service infrastructure 122, using a communication network 120. IM application 100 may include visual remote user identifier 102 of the user (e.g. named “Customer”) with whom the local user is communicating via the IM application 100. IM application 100 may include the chat transcript 104 of the text messages exchanged between the remote user and local user via IM application 100. Transcript 104 may also include any type of data IM application 100 is capable of transmitting, such as text, video, audio, computer files and documents, etc.

IM application 150 may include visual remote user identifier 152 of the remote user (e.g. named “Attorney”) with whom the local user is communicating via the IM application 150. IM application 150 may include the chat transcript 154 of the text messages and data exchanged between the remote user and local user via IM application 152.

IM applications 100 and 150 may contain time-tracking modules (“TTM”) 105 and 155, respectively. TTMs 105 and 155 may allow the users of IM applications 100 and 150, respectively, to record the user's acceptance, duration and history of a time-tracked session over IM. TTMs 105 and 155 may be plug-ins into IM applications 100 and 150, respectively. In other embodiments, TTMs 105 and 155 may be integral components of IM applications 100 and 150, respectively. In other embodiments TTMs 105 and 155 may be components residing either on the user's device or on the network. In yet another other embodiments TTMs 105 and 155 may be integrated with another application, and be either integral to IM applications 100 and 150, plug-ins into IM applications 100 and 150, or otherwise interoperate with IM applications 100 and 150

TTM 105 may include an IM session time indicator 106 (e.g. a counter or timer) showing time elapsed. IM session time indicator 106 displays the time measured by an IM session timer (not shown). Visual indicator 106 may include, or be, a bar graph, a progress bar, or any other type or form of indication of the time. The display of time may be in the standard hours and minutes, may include seconds, days, etc., or may be in anther unit (for example, showing credit or credit used). TTM 105 may include a date-and-time stamp 108 indicating the date and time a session has been accepted. Module 105 may include timing controls for a user to start, stop and record a session. Examples of timing controls include, without limitation, start timing control (or start billing control) 110, stop timing (or stop billing) control 114, and/or record timing (or record billing) control 112. The user may press start billing control 110, labeled “start billing” (in this example the customer and service provider may engage in a billable session), causing IM session timer, and visual indicator 106, to start incrementing and measuring time duration. An acceptance statement 108 me be displayed indicating the date-and-time when a session has been started. In the event the client has declined accepting the timed IM session, the acceptance statement may indicate the client's refusal (or lack of acceptance). An IM session timing initiation message may be sent to the remote IM application 150 indicating the start of timing the IM session (for example, IM session timing initiation message may be sent in response to operation of the start billing control 110.) Upon receipt of the IM session timing initiation message, remote IM application 150 may indicate the date-and-time stamp 158 of the initiation of the session and may start an IM session timer (not shown) to measure elapsed time. The time measured by the IM session timer associated with IM application 150 may be displayed in visual indicator 156. Stop billing control 114 may be used to indicate the end of the timed IM session, and may cause IM session timer to stop. A timed IM session end message may be sent to the remote IM 150, causing IM session timer to stop. A record timed IM session control 112 may be used to preserve and/or export data pertaining to the session (e.g. chat history 104, timer 106, acceptance 108, etc.) to a system of record (e.g. storage, a third-party billing application, email, printing, etc.) In other embodiments, more functions may be available to the user, such as pausing and resuming a session, printing a session, importing session history into a third-party application, emailing a session, etc. While the above embodiments illustrate separate controls for starting and stopping timing of an IM session time, alternate embodiments may have a single control to start and stop IM session timing.

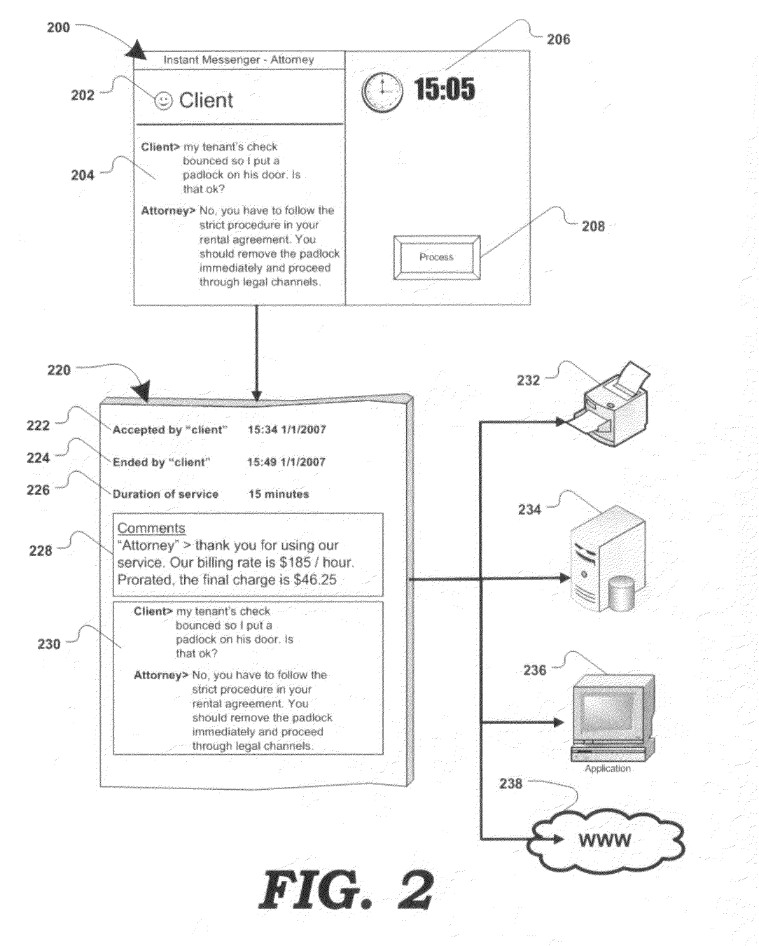

FIG. 2 is a generalized block diagram illustrating an instant messenger application with IM session timing functionality, according to one embodiment. IM application (“IM”) 200 may be used by a user (in this example, user “Attorney”) to engage in an IM session with a remote user (e.g. named “Client” 202). In the presently preferred embodiment the IM session is a chat session. However, in alternate embodiments the IM session may be, or may also include, voice, video, sending and receiving files, etc. Chat transcript 204 may be displayed within IM 200. A IM session time indicator 206 may display the duration of the session between the user of IM 200 and the remote user. A button (e.g. labeled “Process”) 208 may be used to export a session record 220 from IM 200 to one or more external sources, such as printer 232, storage device 234, application 236 and/or network location 238.

IM session timing record 220 may contain data exchanged between the users in the IM session. IM session timing record 220 may include an acceptance record 222 indicating Client's acceptance of the session and the date-and-time stamp of such acceptance. IM session timing record 220 may include a termination time record of the time of the session's termination 224 (e.g. indicating the Client's termination of the billable session and the corresponding date-and-time stamp.) Duration of the session 226 may be computed and recorded, for example from the acceptance record and the termination time record. Alternatively, a session duration record may include information indicating the duration of the timed session. Comments by the users and additional information (e.g. computation of billing amount based on session duration and billing rate) may be recorded in a IM session comment record 228 as part of session record 220. Chat history 230, representing chat transcript 204, may be recorded. In alternate embodiments additional data me be recorded as part of session timing record 220.

IM session timing record 220 may be exported in the same manner as any other electronic data, such a computer file, is exported. IM session timing record 220 may be printed 232. IM session timing record 220 may be saved to any storage device 234 accessible to the IM 200. IM session timing record 220 may be exported into any software application 236 (e.g. an invoicing application which may incorporate the billing information in session record 220 into invoices presented to the Client.) IM session timing record 220 may be exported and/or saved to any network location 238 to the device running the IM application 200, such as anywhere on the world-wide web, intranet, storage area network, local area network (LAN), etc.

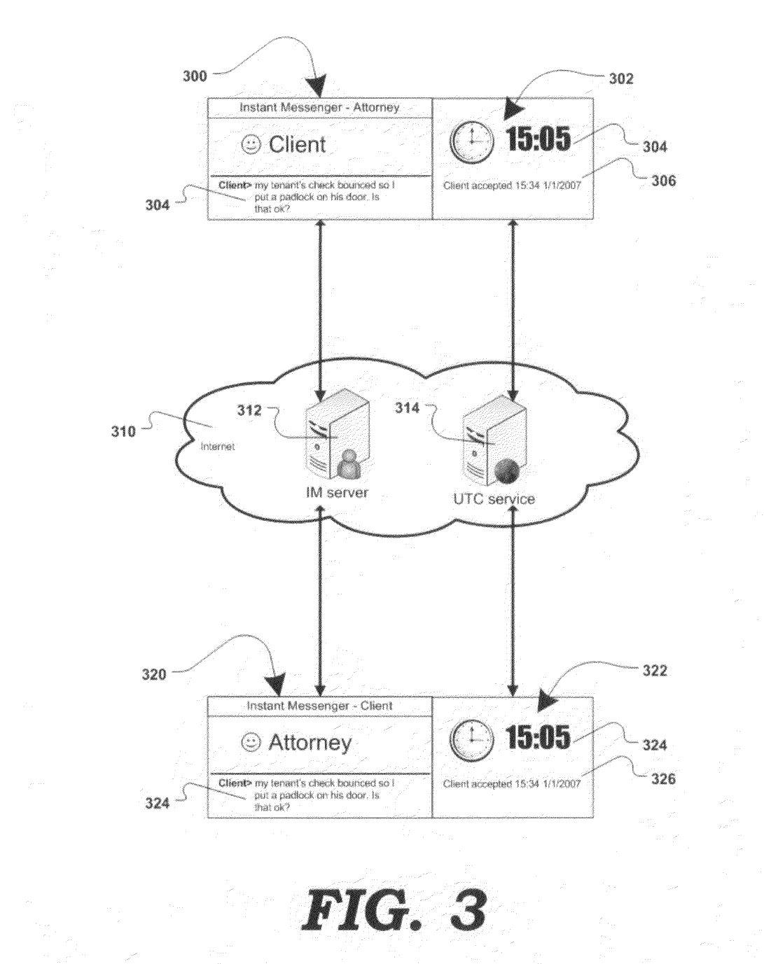

FIG. 3 is a generalized block diagram illustrating the interaction between two instant messenger applications (“IM”) with session tracking, according to one embodiment. Users of IM 300 and IM 320 may engage in a chat session. Chat messages 304 and 324 may be exchanged over IM infrastructure 312 on network 310 (e.g. the world-wide web or an intranet). Additional data may be exchanged between IMs 300 and 320—such as files transferred, voice, video, media, etc. Session-tracking information may be exchanged between IM modules 302 and 322 over the same IM infrastructure 312. IM time-tracking modules (“TTM”) 302 and 322 may contain IM session timers and associated IM session time indicators 304 and 324, respectively, used to measure and indicate the duration of a timed-session. TTMs 302 and 322 may also contain information indicating the acceptance of a timed-session by a user, including the corresponding date-and-time stamps 306 and 326, respectively.

TTMs 302 and 322 may make calls to UTC servers/services 314 for an accurate date/time reading. (UTC, or Coordinated Universal Time is an on-line time system used for many internet and world wide web standards, from chat services to synchronizing individual computers' clocks. “time.windows.com” is an example of one such service.) In the currently-preferred embodiment, TTMs 302 and 322 may each make a call to a UTC service 314 upon the initiation of a timed session to synchronize their respective timers. This may allow for the parties engaged in the timed session to agree on the precise date and time when the session started and ended. (e.g. in situations where the parties are in different physical time zones and/or system clocks on the devices running IMs 300 and 320 may be off, deferring to a UTC may provide an accurate reading on the stating and ending time of sessions, acceptable to all users.) The date and time returned from calls to the UTC service 314 may be presented to the users as “client accepted on date x time y” 306 and 326, and may be recorded as part of the session transcript. In other embodiments, multiple calls to one or more UTC services may be made during the course of a timed session, particularly when the session is paused and then resumed, and at the end of the session, to aid in maintaining IM timing synchronization. At the end of the timed IM session the IM session duration from two or more TTM may be compared to determine whether they agree on the duration of the timed IM session. In the event the times disagree, or in the event the times disagree beyond an acceptable variance (as either a period of time, which may be configurable, or as a percentage of the IM session duration, which may also be configurable) the TTM may display a warning of a discrepancy in the IM session duration. Additionally, a message to one or more TTMs corresponding to IMs participating in the timed IMs session may be sent a timed session discrepancy message. The timed session discrepancy message may request information on the session, or may send information relating to the discrepancy. Other TTMs may display a discrepancy warning upon receipt of the discrepancy message. The discrepancy may also be reported to another application, for example an accounting or billing program. In the event the compared IM session times agree (or agree within acceptable limits), the TTM may display an IM session duration agreement indication. IM session duration agreement may be recorded and/or reported to another application.

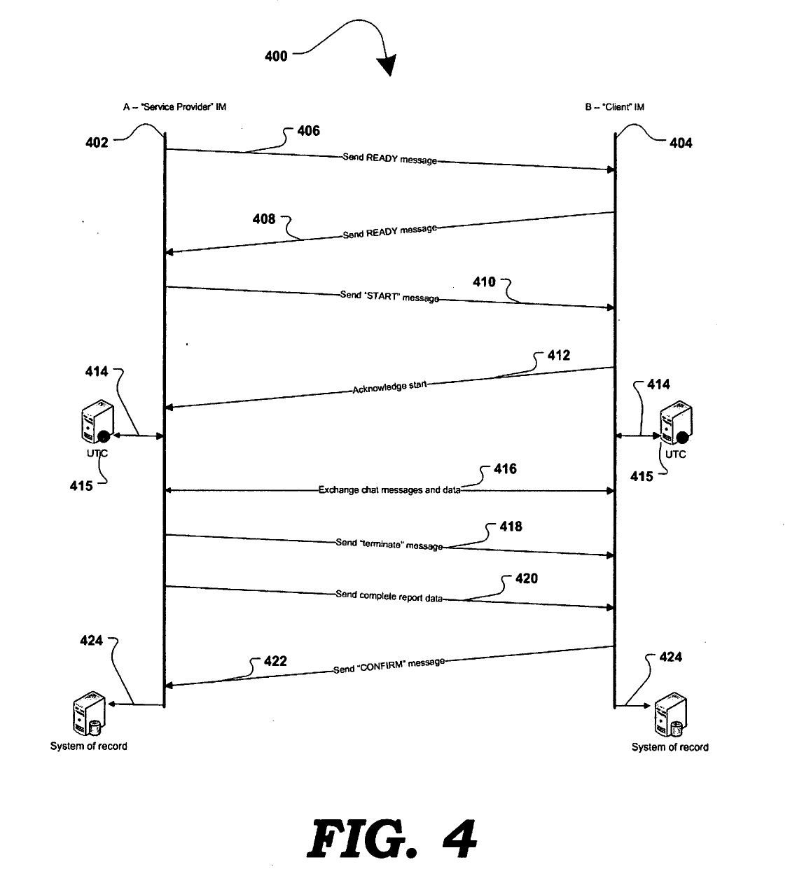

FIG. 4 is a generalized block diagram illustrating a communication flow between two time-tracking modules according to one embodiment. System 400 represents a model where two time-tracking modules (“TTM”) 402 and 404 are able to communicate with each other in a live IM session. For example, System 400 may represent two IM applications, enabled with TTMs 402 and 404, communicating over an IP network as part of a live chat session between the user “Service Provider” of IM application A and the user “Client” of IM application B. TTM 402 may send a timed-session ready message 406 to TTM 404, signaling to TTM 404 that TTM 402 is online and is ready to communicate. In response to ready message 406 received by TTM 404, TTM 404 may send a timed-session ready message 408 to TTM 402 to acknowledge a state of being ready to commence the tracking of time.

In the currently-preferred embodiment, either user may initiate a time-tracked session. The TTM of the IM of the user initiating the timed-session may send a message to the remote TTM indicating the starting of a timed-session. For example, in a case where the “Service Provider” initiates a timed-session, TTM 402 may send a start timed-session message 410 to TTM 404, for example, in response to the user “Service Provider” of TTM 402 taking action to initiate a time-tracked session. TTM 404 may acknowledge start timed-session message 410 with an acknowledge start timed-session message 412, sent back to TTM 402. In alternate embodiments, only one of the users, for example the “client”, may initiate a timed-session; or, only one specific user may initiate a timed-session and another user may accept the time-session, In alternate embodiments various other logic may be used to determine what users may initiate and/or accept a timed-session.

In the currently-preferred embodiment, TTMs 402 and 404 may, at step 414, reference a UTC (Coordinated Universal Time) service 415 to obtain an accurate date-and-time stamp to record the exact starting time of the timed session. The devices engaged in a timed-session may have discrepancies in their respective dates and/or times—for example, as a result of being in different time zones. Referencing UTC services 415 may serve the purpose of recording a uniform date-and-time for the start of a timed session. UTC services 415 may be available on a network (e.g. the World Wide Web) to TTMs 402 and 404. In the currently-preferred embodiment, date-and-time-stamps obtained 414 may be displayed to the users of TTMs 402 and 404.

Data (e.g. text, voice, audio, video, files, etc.) may be exchanged 416 between the IMs of TTMs 402 and 404, as part of a regular IM session. For example, the “service provider” and “client” may engage in a text or voice chat over IM, exchanging files, documents, photos, etc., as generally supported by IM communication.

In the currently-preferred embodiment, any user party to a timed-session may terminate the timed-session. In alternate embodiments, only a specific user may be allowed to terminate a timed-session. (e.g. the user who had started the session; or, only the “client”, or only the “service provide”, etc.) In response to user “service provider” of the TTM 402 terminating the timed-session, TTM 402 may send an terminate timed IM session message 418 to TTM 404. In the currently-preferred embodiment, the TTM 402 terminating the session may also send a timed IM session report 420 (for example, a complete transcript of data exchanged as part of the timed-session) to the remote TTM 404. In alternate embodiments, TTMs 402 and 404 may each send a session transcript to the other TTM, respectively. Additionally, either or both TTMs 402 and 404 may perform an accuracy check at the end of the timed IM session (or at any point during or after the timed IM session) on any of the exchanged information. For example, either or both TTMs 402 and 404 may perform a comparison of the IM session duration to determine whether the two TTMs agree on the duration of the IM session. The results of such a comparison may be exchanged between the two TTMs, and the results of the comparison may be encrypted by one or algorithms to reduce the chances of accidental or intentional tampering with the IM session information or IM session comparison information.

In the currently-preferred embodiment, the remote TTM 404 may respond to messages 418 and 420 from TTM 402, by sending a timed IM session end confirmation message 422, acknowledging the ending of the timed session. TTMs 402 and 404 may export the timed-session transcripts to a system of record 424 (for example, their own respective systems of record such as invoicing applications, storage, printer, etc.)

FIG. 4 illustrates one example of the communication flow and messages exchanged between two TTMs 402 and 404. Note, however, that alternate embodiments may exchange messages in a different sequence, or exchange different messages, in performing IM session timing related functions and tasks.

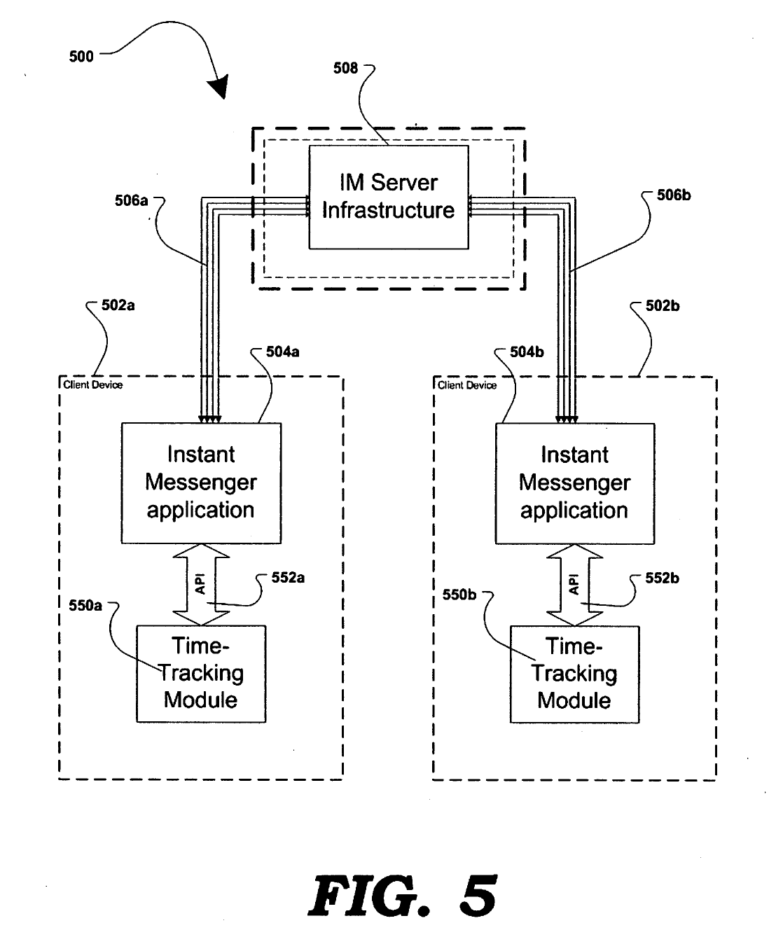

FIG. 5 is a generalized block diagram illustrating a system for tracking time in IM sessions, according to one embodiment. System 500 may include two IM applications 504a and 504b, residing on devices 502a and 502b, respectively, and communicating with one another over IM infrastructure 508. For example, IM applications 504a and 504b may be standalone IM client applications (e.g. Yahoo! Messenger®, Google talk®, Windows Live Messenger®, etc.) running on client devices 502a and 502b, respectively (e.g. personal computers, cellular phones, PDAs, etc.) enabling the users of client devices 502a and 502b to communicate over IM infrastructure 508 (for example, Microsoft Live Communication Server®, Google Talk® server, Yahoo Messenger® server, etc.) Alternatively, IM applications 504a and 504b may be components of other applications (“Third-party applications”) (for example, billing software, time-tracking software, etc.) allowing the third-party applications (or their users) to communicate over an IM infrastructure 508.

IM applications 504a and 504b may contain time-tracking modules (“TTM”) 550a and 550b, respectively. In one possible embodiment, TTMs 550a and 550b may interface with IM applications 504a and 504b, respectively, via API (Application Programming Interface) 552a and 552b, respectively. Communication 506a and 506b between IM applications 504a and 504b may be accessible to TTMs 550a and 550b, respectively, allowing TTMs 550a and 550b to communicate with one another over IM infrastructure 508. TTMs 550a and 550b may utilize API 552a and 552b, respectively, to send one another messages as part of the IM session between IM applications 504a and 504b. For example, TTMs 550a and 550b may communicate to one another the starting and ending of a timed-session between IM applications 504a and 504b. In alternate embodiments TTMs 550a and 550b may utilize API 552a and 552b, respectively, to communicate with IM applications 504a and 504b, capturing a transcript of the timed-session by recording the data communicated between IM applications 504a and 504b. While the example embodiments use an API, other embodiments may exchange information between applications using defined protocols, or any way of exchanging information between applications.

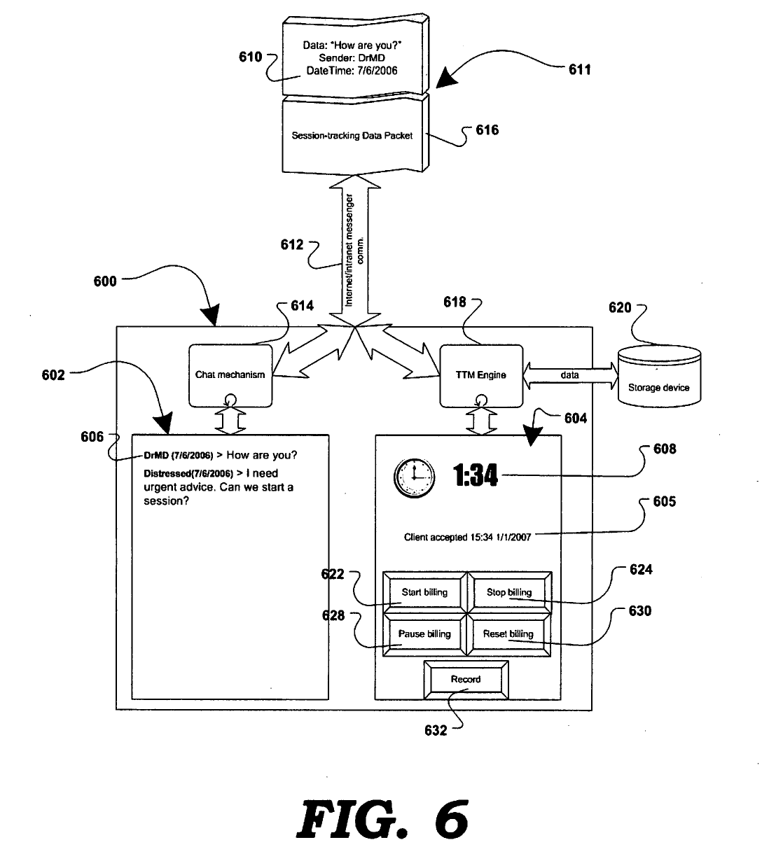

FIG. 6 is a generalized block diagram illustrating the operation of an IM application enabled for tracking a timed IM session, according to one embodiment. IM Application 600 may allow a user to engage in an IM session with remote users via a communications channel 612 (e.g. a network, world-wide-web, intranet, etc) whereby data 611 is exchanged between the user of IM 600 and remote users. In IM application 600 (e.g. Yahoo! Messenger®, Google Talk® IM application, AOL® chat application, Windows Live Messenger®, etc.) data (e.g. chat text, audio, video, binary files, etc.) 611 may be sent and received over a network 612, processed by a chat mechanism 614 and displayed to the user (for example, as text 606) in a chat view area 602.

IM application 600 may contain a time-tracking module (“TTM”) 604. TTM 604 may be a plug-in accessible to IM application 600. In alternate embodiments, TTM 604 may be a component of IM application 600. In another alternate embodiment either, or both, TTM 604 and IM 600 may be components of another application, such as a desktop management and productivity application (e.g. an email and calendaring program such as Outlook™, a word processing application, a spreadsheet application, or any other type of application used on an electronic device).

TTM 604 may allow the user to track the beginning, ending and duration of an IM session on IM application 600 (unless otherwise noted, the IM session being timed is the IM session whose transcript 606 is visible to the user in display 602 of IM application 600.) TTM 604 may include a timer 608 information tracking the duration of an IM session. TTM 604 may include data indicating the date-and-timestamp 605 of the start of a timed-session. TTM 604 may include a control for the user to start (e.g. button “Start Session” 622 button) a timed session; a control for stopping (e.g. “Stop Session” 624 button) a timed-session; a control for pausing a timed-session (e.g. “Pause Session” 628 button); means of resetting a session (e.g “reset session” 630 button); and means of recording a session (e.g. “record session” 632 button.) In alternate embodiments, other session-tracking functionality may be available to the user.

In the presently-preferred embodiment, data related to session-tracking 616 (e.g. session-timer 608 information, data indicating session start 622/pause 628/stop 624 information, etc.) may be exchanged between IM application 600 and remote IM applications. In the presently-preferred embodiment, session-tracking data 616 may be sent and received along with other chat data 610 (e.g. text, audio, video, computer files, etc.) over communication channel 612. Received data 611 may be processed by IM application 600 for display to the user. IM application 600 may process chat-related data 606 for display to the user as part of the chat functionality in the chat view area 602. Session-tracking-related data 616 may be processed by the TTM engine 618 for display to the user in TTM 604.

Chat-related data 606, received from or input by the user of IM 600, may be processed by chat mechanism 614 and sent, over communications channel 612, to a remote IM and received as data 610. Session-tracking data (e.g. 608, 605, etc.) in TTM 604 may be processed by the TTM engine 618 and sent, over communications channel 612, to a remote IM and received as data 616. Session-tracking data processed by TTM engine 618 may be stored, for example by a storage device 620.

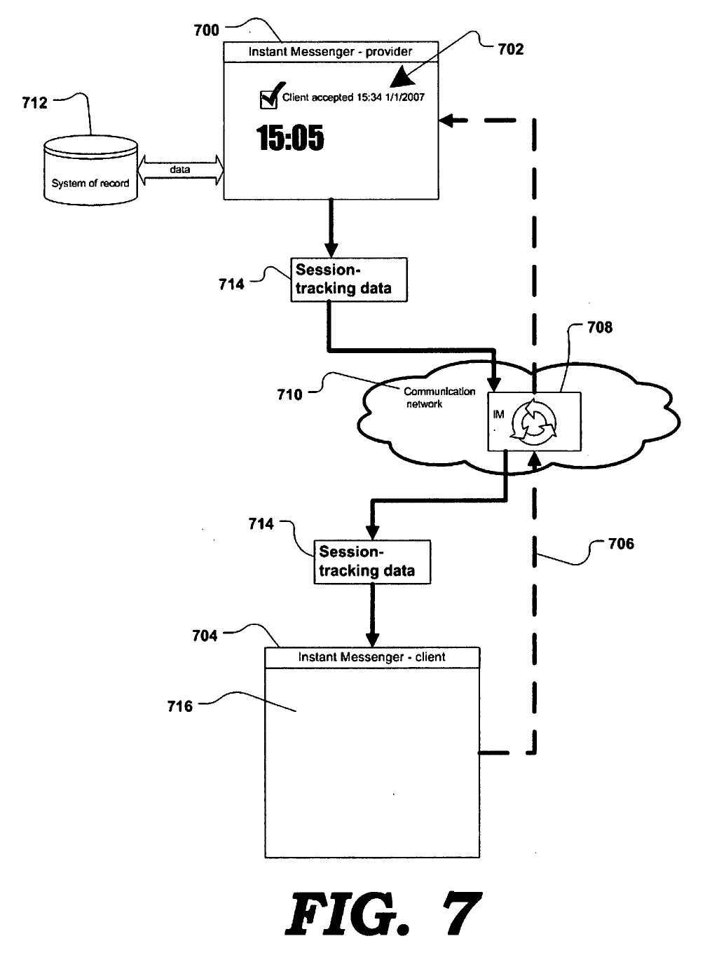

FIG. 7 is a generalized block diagram illustrating synchronization of data between IM applications which allow tracking a timed IM session, according to one embodiment. IM applications 700 and 704 may exchange session-tracking information over IM service 708 on communication network 710. TTM module 702, accessible to IM application 700, may contain (or access) session-tracking information (e.g. session-tracking information pertaining to an IM session between IM application 700 and IM application 704.) TTM 702 may have access to an IM session timing information record store 712.

A TTM 716, associated with IM application 704, may send a querying message 706 to a remote TTM 702, requesting session-tracking data accessible to TTM 702. (e.g. session-tracking data currently displayed in TTM 702 or that is accessible to TTM 702.) Session-tracking data 714 may be sent to IM application 704, over IM infrastructure 708, and received by TTM 716. In alternate embodiments, TTM 716 may automatically send query messages 706 either at predetermined intervals, or in response to an event, such as loss of network connectivity. Receipt of query message 706 by TTM 702 may cause TTM 702 to send session-tracking data 714, via IM infrastructure 708, to the requesting TTM 716. In response to receiving session-tracking data 714, TTM 716 may re-display or update session-tracking data displayed in TTM 716, keeping it synchronized with session-tracking data displayed in TTM 702.

It should be noted that in the example above, TTM 716 is shown requesting session-tracking data from TTM 702. This specific flow is shown for illustrative purposes only. Alternate embodiments may operate where TTM 702 requests data from TTM 716 and TTM 716 responds by sending data to TTM 702. For example, TTM 702 may request IM session tracking data, and TTM 716 may respond with the requested IM session tracking data.

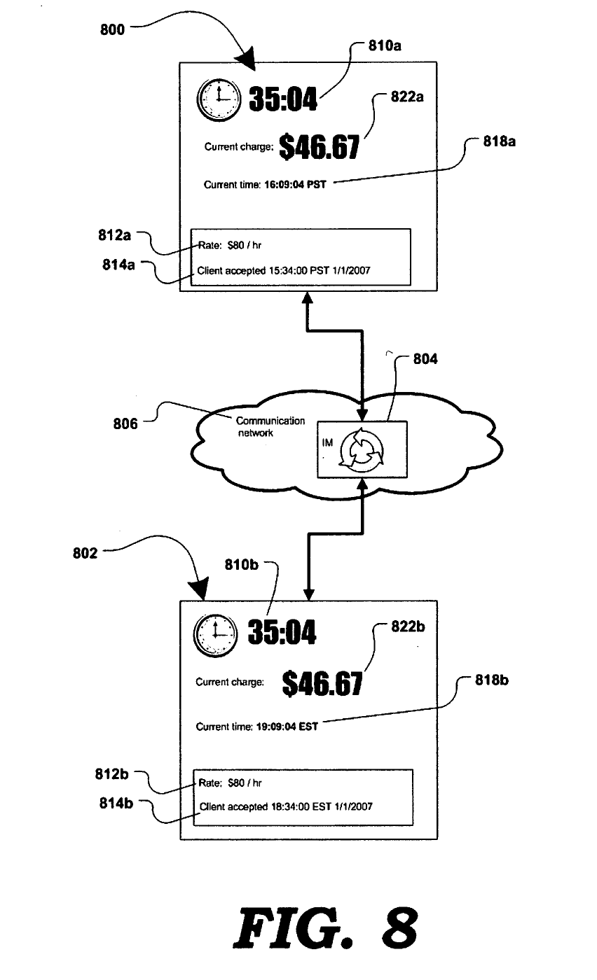

FIG. 8 is a generalized block diagram illustrating the association of an IM session rate, such as a monetary rate, to time-tracked IM sessions, according to one embodiment. IMs capable of session-time-tracking (“STIM”) 800 and 802 may exchange session-tracking data over IM infrastructure 804 on network 806. The embodiment illustrated in FIG. 8 is described with a monetary rate in dollars as the IM session rate for the purposes of illustration. Alternate embodiments may use monetary rates in other currencies, or may use value information which is not a monetary rate, for example in points or credits, as the IM session rate. A monetary rate may be displayed in IM session rate displays 812a and 812b. In the presently preferred embodiment, the displayed monetary rate corresponds to the IM session tracked by STIMs 800 and 802. For example, in the context of professional services rendered over IM, the users of STIMs 800 and 802 may agree on a rate, such as $80 per hour. The agreed-upon rate may be displayed 812a and 812b to both users. A “current charge” may be displayed to both users in an IM session charge display 822a and 822b. As different rates, currencies, or value information may be used in different chat sessions, one or more of the STIMs may allow for selection of a monetary rate or value information, or may also allow input of a monetary rate or value information for the IM session rate. For example, a service provider may select a particular rate for a given type of work, or a particular client. The selected monetary rate or value information is transmitted to the clients STIM and may be displayed in the associated IM session rate display of the clients STIM.

The current IM session charge may be computed by STIM 800 and/or STIM 802, respectively, by multiplying the duration of the time-tracked session by the IM session rate. The duration of the time-tracked session may be computed by STIMs 800 and/or 802 by subtracting the current time from the time in which the time-tracked session had been accepted. For example, the tracked session was accepted, as indicated in the IM session acceptance indicator 814a, at 15:34:00 PST. The current time displayed in the current time indicator 818a is 16:09:04 PST. The time difference, in this example 35 minutes and 4 seconds, may be shown in IM session duration indicators 810a and 810b to both users. The current charge of $46.67 may be derived by multiplying the time elapsed, as shown in IM session time indicators 810a and 810b (e.g. 35:0) by the IM session displayed in the IM rate 812a and 812b (e.g. $80 per hour). In the presently-preferred embodiment, session duration, and current charge, may be updated frequently, such as in one-second increments. In alternate embodiments, session duration, and current charge, may be updated at various other times and intervals, for example, in round-dollar increments of current charge; or upon a periodic synchronization of STIMs 800 and/or 802; or upon a user request, etc. Times may be displayed according to the user's locale. Times shown in the client acceptance indicator 814a and current-time indicator 818a may be shown as 15:34:00 PST and 16:09:04 PST, respectively, for a user whose locale is in Pacific Standard Time; and, times shown in client acceptance indicator 814b and current-time indicator 818b may be shown as 18:34:00 EST and 19:09:04 EST, respectively, for a user whose locale is in Eastern Standard Time.

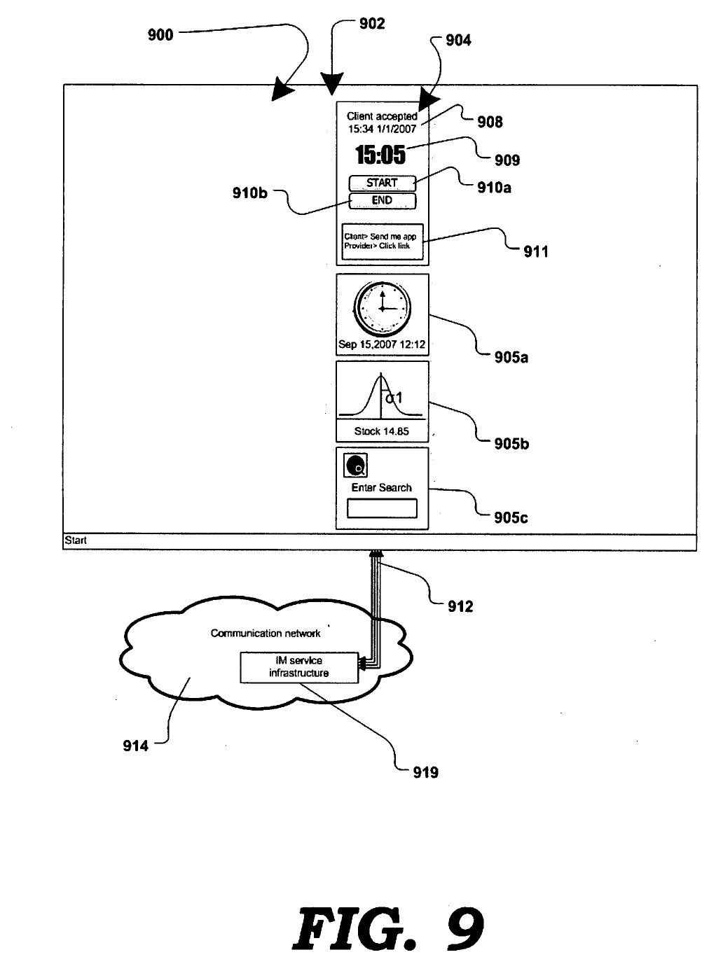

FIG. 9 is a generalized block diagram illustrating the use of a “widget” for tracking IM sessions, according to one embodiment of the present invention. Widgets, or gadgets are small computer applications, typically residing on a user's desktop, that perform a variety of functions and may be hosted by an application—or “engine”—which acts as an interface between the widgets/gadgets/plug-ins (“widgets”) and the operation system of the user's device. The desktop 900 of a user device's may contain an application 902 (e.g. Yahoo!® Widget Engine or Google® Desktop/Sidebar, etc.) capable of hosting a widget or widgets (e.g. a clock 905a, a stock ticker 905b, a search widget 905c, an IM 904, etc.) An IM widget 904, capable of session-time-tracking (“STIM”), may communicate with remote STIMs over an IM infrastructure 919 (e.g. Google Talk® or Yahoo! IM services) on a network 914, such as the world-wide web.

STIM widget 904 may allow a user to chat with remote users (the term chat is used herein as a collective term for typical IM functionality, which may include chatting via text, voice, sending and receiving files, etc.) The user of STIM widget 904 may indicate the acceptance of a time-tracked IM session (e.g. by clicking the “Start” button 910a.) The user may be displayed the date-and-time stamp of the accepted timed-session in the IM session acceptance display 908. A counter-display 909 may display the elapsed time from the point the time-tracked session was accepted/initiated. The elapsed time tracked by the counter may be displayed in the IM session elapsed time indicator. The user may indicate the ending of the time-tracked session (e.g. by clicking the “End” button 910b.)

In the currently-preferred embodiment, STIM widget 904 may send data pertaining to the tracked IM session—e.g. user's acceptance of the tracked session, user's ending the tracking of the session, duration of the tracked session, etc.—to the remote STIM. STIM widget 904 may receive session-tracking data from the remote STIM. In alternate embodiments, STIM 904 may track sessions unilaterally, i.e. through interfacing with IM applications not capable of tracking sessions. For example, the user of STIM 904 may click on the start button 910a and end button 910b during a chat session, for their own personal record, with no time-tracking-related interaction with the remote-IM application.

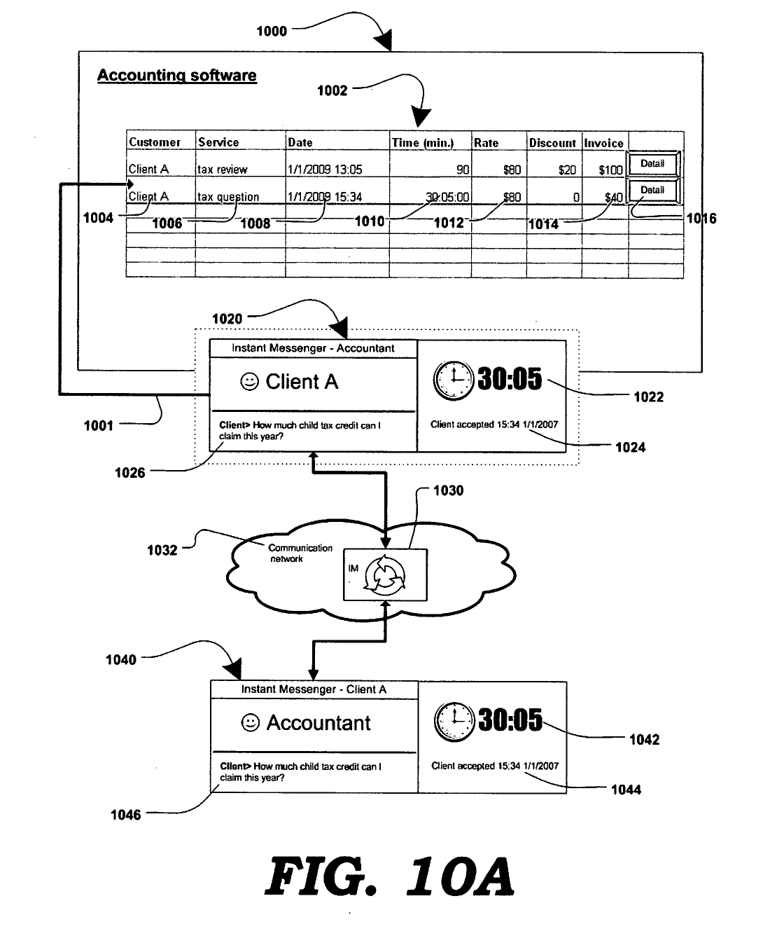

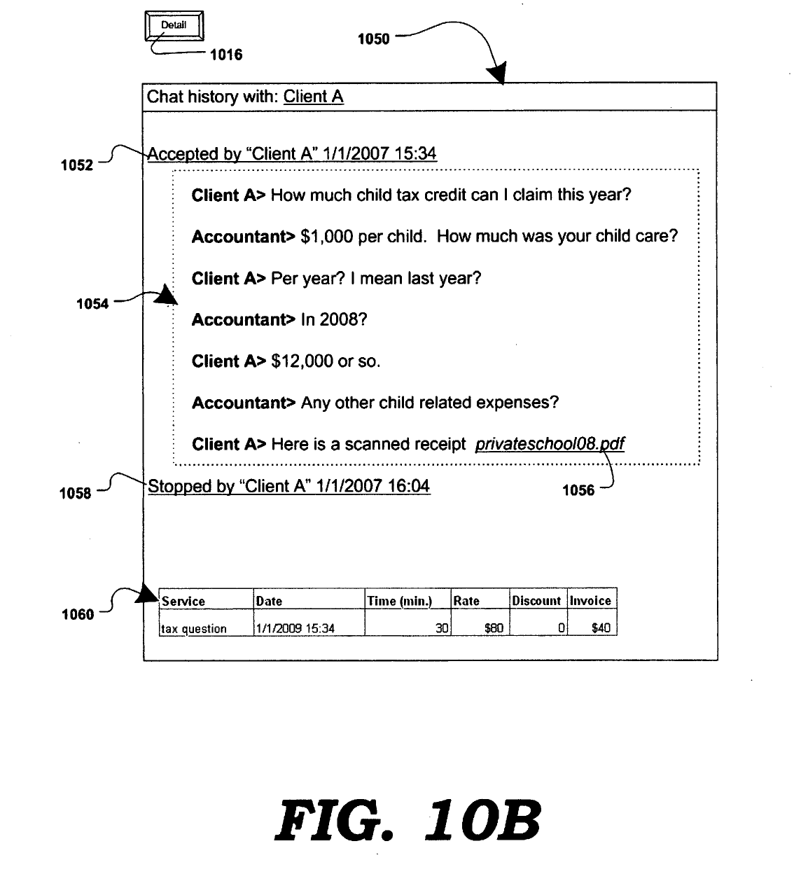

FIGS. 10A and 10B are generalized block diagrams illustrating the interaction of session-tracking IMs with a system of record, according to one embodiment of the present invention. Referring to FIG. 10A, Session-tracking IMs (“STIM”) 1020 and 1040 may exchange data (e.g. text, voice, files, etc.) over IM service 1030 on communication network 1032. STIM 1020 (in this example labeled “Accountant” and chatting with remote user “Client 38 ) may be engaged in a time-tracked session with a remote STIM 1040 (in this example, labeled “Client A” and chatting with remote user “Accountant”.) The users of STIMs 1020 and 1040 may exchange chat messages (e.g. “How much child tax credit can I claim this year?”) displayed on both STIMs 1020 and 1040 as messages 1026 and 1046, respectively. STIMs 1020 and 1040 may display the date-and-time stamps 1024 and 1044, respectively, when the current time-tracked session has been started. STIMs 1020 and 1040 may display the duration 1022 and 1042, respectively, of the current time-tracked session.

A STIM 1020 may interface with a system of record 1000 (e.g. an accounting application, a bookkeeping application, a time-keeping application, a productivity application, a database, etc.). STIM 1020 may communicate 1001 with the system of record application 1000 (“application”) via API made available through the application 1000; or, through API made available by STIM 1020; or, STIM 1020 may be a part of application 1000; or, application 1000 may be a part of STIM 1020; or through a DDE or COM or SOAP or web mechanism. In alternate embodiments, other means of interface 1001 between STIM 1020 and application 1000 may be possible.

Data produced in a session between STIMs 1020 and 1040 (e.g. typed chat text, audio, video, files exchanged, session starting time, session ending time, session duration, etc.) may be stored in application 1000. In the currently-preferred embodiment, application 1000 may contain a set of records 1002 (“record set”) which may be mapped to data produced in a session between STIMs 1020 and 1040. In one example, application 1000 may be accounting software used by an accountant when engaged in a billable IM session with Client A, with record set 1002 containing records of services rendered by the accountant to Client A 1004. In this example, general information pertaining to billing may be kept, e.g. the type of service 1006, the date the service was rendered 1008, the total billable time 1010, the billing rate 1012, the invoice amount 1014, and a link to the transcript of the service rendered 1016.

In the currently-preferred embodiment, data generated in the session between STIMs 1020 and 1040 may be associated with record set 1002. The name “Client A” of the remote user of STIM 1040 may be recorded 1004 in record set 1002, in the “Customer” column. The date and time of the commencement of a billable IM session—shown as “15:34 1/1/2007” 1024 and 1044 in STIMs 1020 and 1040, respectively, may be recorded in records 1002 in the “Date” column 1008. The duration “30:05” 1022 and 1042 of the billable session may be recorded “30:05:00” 1010 in the “Time” column of records 1002. The transcript of the entire session between STIMs 1020 and 1040 may be recorded and made accessible 1016 in application 1000. Additional information pertaining to a session between STIMs 1020 and 1040 may be automatically recorded in record set 1002 of application 1000. As the example embodiment illustrates, IM session information, or data, may be associated with the record set, with individual records, or with data values in one or more record elements.

Referring now to FIG. 10B, session transcript 1050 of the tracked session between STIMs 1020 and 1040 may be recorded in record set 1002 of application 1000 (See FIG. 10A.) Session transcript 1050 may contain the date-and-time stamp 1052 of the acceptance/starting of a tracked-session, as recorded 1024 and 1044 by STIMs 1020 and 1040, respectively. Session transcript 1050 may contain the date-and-time stamp 1058 of the ending of a tracked-session, as recorded by STIMs 1020 and 1040. Session transcript 1050 may contain the chat history/transcript between the users of STIMs 1020 and 1040, including any files 1056 exchanged as part of the IM session. In alternate embodiments, session transcript 1050 may contain any additional data presented as part of a tracked-session (e.g. table 1060 summarizing the billable session which may be generated by the STIMs 1020 and 1040 and appended to the session record.) Chat transcript 1050 may contain any additional data generated as part of the tracked IM session between STIMs 1020 and 1040.

While the above example embodiments had two IM clients in a timed IM session, alternate embodiments may allow three or more IM clients to participate in a timed IM session. For example, a service provider such as an accountant may chat with two employees of a company in a timed IM session. In one possible embodiment the IM session timer would record the entire time of the chat session, such that the timing would begin when the first person started the chat session, thereby allowing others to join the chat session without resetting the IM session timer. Additionally, one or more “client” or “time chat purchaser” participants leaving the timed IM session may not stop the IM session timer, if another “client” or “time chat purchaser” participant remains in the chat session.

The examples above demonstrate the power and flexibility of the present invention in providing a means for enhancing instant messenger services by adding and incorporating a framework for a peer-to-peer tracking IM session-duration among instant messenger users.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of tracking an IM session, comprising:
receiving IM session start information;
initiating an IM session counter in response to receiving the IM session start information;
receiving IM session end information;
stopping the IM session counter in response to receiving the IM session end information; and
calculating an IM session value from an IM session time corresponding to the IM session counter and an IM session rate.

2. The method of claim 1, wherein the IM session start information is received in response to selection of an IM session start control.

3. The method of claim 2, wherein the IM session end information is received in response to selection of an IM session end control.

4. The method of claim 1, wherein the received IM session start information includes start IM session acceptance information.

5. The method of claim 1, further comprising:
reporting the calculated IM session value to a desktop productivity application.

6. The method of claim 5, further comprising:
reporting the calculated IM session value to a client billing application.

7. The method of claim 1, wherein the IM session end information is received from an IM session inactivity timer.

8. The method of claim 1, further comprising:
requesting an acceptance for timing an IM session from at least one participant in the IM session.

9. The method of claim 8, wherein timing of the IM session initiates after receiving acceptance indication for timing an IM session from at least one participant in the IM session.

10. The method of claim 9, wherein the received acceptance includes information specifying acceptance of a IM session rate.

11. The method of claim 9, wherein the acceptance indication is received from a timing module associated with an IM client, the timing module and IM client associated with the at least one participant in the IM session.

12. The method of claim 1, further comprising:
connecting a time synchronization source; and
adjusting the counter in accordance with time information received from the time synchronization service.

13. The method of claim 1, further comprising:
receiving IM session time information from a timer associated with an IM corresponding to at least one other participant in the IM session;
determining whether the received session time information corresponds to the session time from the IM session counter; and
generating an alert if the received session time information does not correspond to the session time from the IM session counter.

14. The method of claim 13, wherein correspondence between the received session time information and the session time from the IM session counter are within a time allowance factor.

15. A method of presenting a graphical user interface for tracking IM sessions, comprising:
presenting an IM session duration indicator;
presenting an IM session timing start control;
presenting an IM session timing end control; and
presenting an IM session charge display.

16. The method of claim 15, further comprising:
presenting an IM time session timing acceptance control.

17. The method of claim 16, further comprising:
presenting an IM session timing acceptance indication.

18. The method of claim 15, further comprising:
presenting an IM session rate display.

19. The method of claim 15, wherein the IM session charge display displays a charge in monetary units.

20. The method of claim 15, wherein the graphical display is part of an IM client.

21. The method of claim 15, wherein the graphical display is a widget for use with an electronic device.
